(19) United States
(12) Patent Application Publication
(10) Pub. No.: US 2025/0298225 A1
(43) Pub. Date: Sep. 25, 2025

(54) OPTICAL PROJECTION SYSTEM AND ELECTRONIC DEVICE

(71) Applicant: Goretek OPtical Technology Co., Ltd., Shandong (CN)

(72) Inventor: Yun Zhao, Shandong (CN)

(73) Assignee: Goertek Optical Technology Co., Ltd, Shandong (CN)

(21) Appl. No.: 18/860,792

(22) PCT Filed: Jun. 28, 2022
(86) PCT No.: PCT/CN2022/102019

§ 371 Date: Oct. 28, 2024

(30) Foreign Application Priority Data
Apr. 29, 2022 (CN) 202210473565.6

(51) Int. Cl. G02B 15/14; G02B 13/16

(52) U.S. Cl. CPC G02B 15/1425; G02B 13/16

(57) ABSTRACT

The present disclosure provides an optical projection system and an electronic device. The optical projection system includes from a zoom-in side to a zoom-out side: a first lens group and a second lens group sequentially arranged along an optical axis, and the second lens group has a positive focal power; the first lens group comprises a negative lens group and a positive lens group, the positive lens group is located closer to the zoom-out side than the negative lens group, the negative lens group comprises at least one lens with a negative focal power, and the positive lens group comprises at least one lens with a positive focal power; the negative lens group and the positive lens group are provided with a first air gap greater than 9.5 mm therebetween.

### CROSS-REFERENCE TO RELATED APPLICATIONS

The present disclosure is a National Stage of International Application No. PCT/CN2022/102019, filed on Jun. 28, 2022, which claims priority to a Chinese patent application No. 202210473565.6 filed with the CNIPA on Apr. 29, 2022, both of which are hereby incorporated by reference in their entireties.

### TECHNICAL FIELD

The present disclosure relates to the technical field of optical devices, and particularly to an optical projection system and an electronic device.

### BACKGROUND

The optical projection system is developing rapidly and is widely used in various fields. For example, the projection optical system is used in digital light processing (DLP) projection devices. However, the lens system used in the optical projection device still needs to possess high optical performance as well as convenience and portability.

Nevertheless, achieving high optical performance makes it difficult to miniaturize the lens system, and miniaturizing such a lens system increases manufacturing costs. Therefore, it is challenging to satisfy both high optical performance and low manufacturing costs simultaneously.

### SUMMARY

An objective of the present disclosure is to provide a new technical solution for an optical projection system and an electronic device.

According to a first aspect of the present disclosure, an optical projection system is provided, which includes: a first lens group and a second lens group sequentially arranged along an optical axis, and the second lens group has a positive focal power; the first lens group includes a negative lens group and a positive lens group, the positive lens group is located closer to the zoom-out side than the negative lens group, the negative lens group includes at least one lens with a negative focal power, and the positive lens group includes at least one lens with a positive focal power;

the negative lens group and the positive lens group are provided therebetween with a first air gap greater than 9.5 mm.

Optionally, the first lens group and the second lens group are provided with a stop therebetween; the first lens group and the stop are provided with a second air gap therebetween, and the second air gap is greater than 8 mm and less than 11 mm; and/or the second lens group and the stop are provided with a third air gap therebetween, and the third air gap is 1.5% to 4.5% of a total optical length of the optical projection system.

Optionally, in the negative lens group, the lens with a negative focal power has a concave surface closer to the zoom-out side, and an edge tangent of the concave surface forms an angle ranging from 30° to 50° with the optical axis.

Optionally, from the zoom-in side to the zoom-out side, the negative lens group includes a first lens, a second lens, and a third lens, each having a negative focal power.

Optionally, from the zoom-in side to the zoom-out side, the positive lens group includes a fourth lens with a positive focal power; or, the positive lens group includes a fourth lens and a fifth lens, each having a positive focal power.

Optionally, sum of the focal power of the first lens, the second lens and the third lens ranges from −0.16 to 0.14.

Optionally, from the zoom-in side to the zoom-out side, clear aperture of the lenses in the optical projection system gradually decreases.

Optionally, the first lens has a thickness greater than that of the second lens, and the second lens has a thickness greater than that of the third lens.

Optionally, the first lens, the second lens, and the third lens each has a first surface and a second surface, the second surface is closer to the zoom-out side, and the second surfaces of the first lens, the second lens and the third lens are all concave surfaces:
an edge tangent of the second surface of the first lens forms an angle of 30° to 40° with the optical axis:
an edge tangent of the second surface of the second lens forms an angle of 30° to 40° with the optical axis:
an edge tangent of the second surface of the third lens forms an angle of 40° to 50° with the optical axis.

Optionally, the first lens is an aspherical lens, and the first lens and the second lens are provided therebetween with a fourth air gap greater than 10 mm.

Optionally, from the zoom-in side to the zoom-out side, the second lens group includes a sixth lens, a seventh lens, an eighth lens and a ninth lens, with focal powers of the second lens group being in an order of positive, negative, positive, and positive.

Optionally, the sixth lens, the seventh lens and the eighth lens are cemented together to form a triple-cemented lens, and in the triple-cemented lens, a lens with a positive focal power has refractive index smaller than that of a lens with a negative focal power.

Optionally, the ninth lens is an aspherical lens, and an air gap between the triple-cemented lens and the ninth lens is less than 1 mm and greater than 0.1 mm.

According to a second aspect of the present disclosure, an electronic device is provided, which includes the optical projection system as described in the first aspect.

In the embodiments of the present disclosure, an optical projection system is provided. The optical projection system includes a first lens group and a second lens group. The first lens group includes a negative lens group and a positive lens group. The optical projection system in the embodiments of the present disclosure has a simple structure. The embodiments of the present disclosure limit the air gap between the negative lens group and the positive lens group, thereby ensuring that the light emergent from the negative lens group is incident into the positive lens group at a high incidence height, and that the positive lens group may provide a large positive focal power for the first lens group. The positive lens group provides a large positive focal power to better combine with the lens with a negative focal power in the negative lens group, thus better correcting imaging aberrations.

The other features and advantages of the present disclosure will become clear through the following detailed description of exemplary embodiments with reference to the accompanying drawings.

### BRIEF DESCRIPTION OF THE DRAWINGS

In order to clearly illustrate embodiments of the present disclosure or technical solutions in the prior art, accompanying drawings that need to be used in description of the embodiments or the prior art will be briefly introduced as follows. Obviously, drawings in following description are only the embodiments of the present disclosure. For those skilled in the art, other drawings may also be obtained according to the disclosed drawings without creative efforts.

FIG. 1 illustrates a structural diagram 1 of an optical projection system in an embodiment of the present disclosure.

FIG. 2 illustrates an optical path diagram of the optical projection system of FIG. 1.

FIG. 3 illustrates a chromatic aberration diagram of the optical projection system of FIG. 1.

FIG. 4 illustrates a distortion diagram of the optical projection system of FIG. 1.

FIG. 5 illustrates a modulation transfer function diagram of the optical projection system of FIG. 1.

FIG. 6 illustrates a dot matrix diagram of the optical projection system of FIG. 1.

FIG. 7 illustrates a structural diagram of a first lens group in the optical projection system.

FIG. 8 illustrates a structural diagram II of the optical projection system in an embodiment of the present disclosure.

FIG. 9 illustrates an optical path diagram of the optical projection system of FIG. 8.

FIG. 10 illustrates a chromatic aberration diagram of the optical projection system of FIG. 8.

FIG. 11 illustrates a distortion diagram of the optical projection system of FIG. 8.

FIG. 12 illustrates a modulation transfer function diagram of the optical projection system of FIG. 8.

FIG. 13 illustrates a dot matrix diagram of the optical projection system of FIG. 8.

### DESCRIPTION OF REFERENCE SIGNS

1. first lens; 2. second lens; 3. third lens; 4. fourth lens; 5. fifth lens; 6. sixth lens; 7. seventh lens; 8. eighth lens; 9. ninth lens; 10. image source; 11. flat glass; 12. prism; 13. stop;
30. first lens group; 40. second lens group.

### DETAILED DESCRIPTION

Various exemplary embodiments of the present disclosure will now be described in detail with reference to the accompanying drawings. It is to be noted that unless otherwise specified, the scope of present disclosure is not limited to relative arrangements, numerical expressions and values of components and steps as illustrated in the embodiments.

Description to at least one exemplary embodiment is for illustrative purpose only, and in no way implies any restriction on the present disclosure or application or use thereof.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Different values may be available for alternative examples of the exemplary embodiments.

It is to be noted that similar reference numbers and alphabetical letters represent similar items in the accompanying drawings. In the case that a certain item is identified in a drawing, further reference thereof may be omitted in the subsequent drawings. The present disclosure provides an optical projection system applied to a projector or an illuminator.

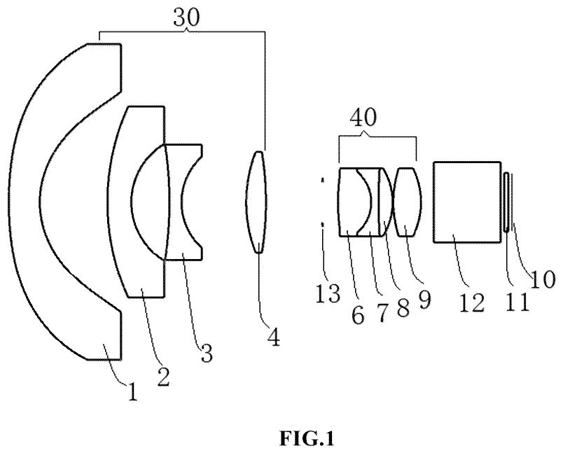

Referring to FIGS. 1, 2 and 8 to 9, the optical projection system includes, from a zoom-in side to a zoom-out side: a first lens group 30 and a second lens group 40 sequentially arranged along an optical axis; the first lens group 30 has a negative focal power, and the second lens group 40 has a positive focal power.

The first lens group 30 includes a negative lens group and a positive lens group, the positive lens group is located closer to the zoom-out side than the negative lens group, the negative lens group includes at least one lens with a negative focal power, and the positive lens group includes at least one lens with a positive focal power.

The negative lens group and the positive lens group are provided therebetween with a first air gap greater than 9.5 mm.

In other words, the optical projection system of the present disclosure is applied to a projection device, and includes a zoom-out side and a zoom-in side along the light transmission direction. An image source 10, a flat glass 11, a prism 12, the second lens group 40, and the first lens group 30 of the optical projection system are sequentially provided between the zoom-out side and the zoom-in side along the same optical axis. Here, the zoom-out side is the side where the image source 10 (such as the DMD chip) that generates the projection light is located during the projection process, also known as the image side; the zoom-in side is the side where the projection surface (such as the projection screen) that displays the projected image is located during the projection process, also known as the object side. The transmission direction of the projection light is from the zoom-out side to the zoom-in side. However, when actually designing the optical projection system, the light is simulated from the actual zoom-in side to the zoom-out side according to the principle that the optical path is reversible.

Specifically, during the actual projection process, the projection light is emitted from the image source 10, travels from the zoom-out side to the zoom-in side, sequentially passing through the flat glass 11, the prism 12, the second lens group 40, and the first lens group 30, thus displaying the projected image.

In embodiments of the present disclosure, the image source 10 may opt for a digital micromirror device (DMD) chip. A DMD consists of a number of digital micro-reflectors arranged in a matrix, each of which may be deflected and locked in both the positive and negative directions during operation such that the light is projected in a given direction, and oscillates at a frequency of tens of thousands of hertz so that the light beam from the illumination source is reflected by the flip of the micro-reflectors into the optical system and imaged on the screen. The DMD has advantages such as high resolution and no need for digital-to-analog signal conversion. The optical projection system of the present disclosure is applied to a design of 0.23″ DMD with a projection ratio of 0.5 and a 144% offset (off-axis). Of course, the image source 10 may also opt for Liquid Crystal On Silicon (LCOS) chips or other display elements that may be used for exiting light, which is not limited in the present disclosure.

Specifically, for the entire optical projection system, the first lens group 30 has a negative focal power, and the second lens group 40 has a positive focal power. The first lens group 30 and the second lens group 40 ensure the balance of the focal power of the entire optical projection system.

In the embodiment, the focal power of the first lens group 30 is negative, the incident light may enter the optical projection system at a large negative incident angle and finally enter the positive lens group at a small positive incident angle, and the lens with the negative focal power arranged adjacent to the positive lens group diverges the light.

In the embodiment, the first lens group 30 includes a negative lens group and a positive lens group, with the positive lens group located closer to the zoom-out side than the negative lens group. That is, from the zoom-in side to the zoom-out side, the first lens group 30 includes both the negative lens group and the positive lens group. Specifically, the negative lens group consists solely of lenses with negative focal powers, while the positive lens group consists solely of lenses with positive focal powers. Therefore, the overall focal power of the negative lens group is negative, and the overall focal power of the positive lens group is positive. The overall focal power of the negative lens group and the overall focal power of the positive lens group cooperate with each other, so that the overall focal power of the first lens group 30 is balanced.

The present disclosure also limits the first air gap between the negative lens group and the positive lens group, to ensure the balance of focal power in the first lens group 30 and to better correct aberrations. In the embodiment, the first air gap between the positive lens group and the negative lens group is greater than 9.5 mm, which means to widen the gap between two lenses that are adjacently arranged in the positive and negative lens groups, ensuring that the light is incident into the positive lens group at a higher incidence height.

In a specific embodiment, particularly in the first embodiment; the first air gap between the positive lens group and the negative lens group is 5 mm, light in one field of view emergent from the negative lens group is incident into the positive lens group at point A on the lens in the positive lens group (the lens adjacent to the negative lens group), wherein the point A is located above the optical axis. Particularly in the second embodiment; when the first air gap between the positive lens group and the negative lens group is 10 mm, light in the same field of view emergent from the negative lens group is incident into the positive lens group at point B on the lens in the positive lens group (the lens adjacent to the negative lens group), wherein the point B is located above the optical axis. Since the air gap between the positive and negative lens groups is widened in the second embodiment, the incidence position B is higher than incidence position A.

Specifically, in the first lens group 30, the positive lens group includes at least one lens with a positive focal power, which lens needs to provide a greater focal power. The focal power of the lens is related to the height at which the light is incident into the lens; the higher the incidence height, the greater the provided focal power. In the embodiment, in the negative lens group, the lens with a negative focal power provided adjacent to the positive lens has the function of diverging the light, and the air gap between the positive and negative lens groups is widened, thereby ensuring that the light is incident into the positive lens group at a higher position, so as to maintain the balance of focal power in the first lens group 30 and better correct aberrations.

In an embodiment, referring to FIGS. 1 and 8, a stop 13 is provided between the first lens group 30 and the second lens group 40; a second air gap is provided between the first lens group 30 and the stop 13, and the second air gap is greater than 8 mm and less than 11 mm; and/or a third air gap is provided between the second lens group 40 and the stop 13, and the third air gap is 1.5% to 4.5% of a total optical length of the optical projection system.

In the embodiment, limitations are made to the air gap between the first lens group 30 and the stop 13, and the air gap between the second lens group 40 and the stop 13 so as to make the optical projection system more compact while satisfying the imaging effect.

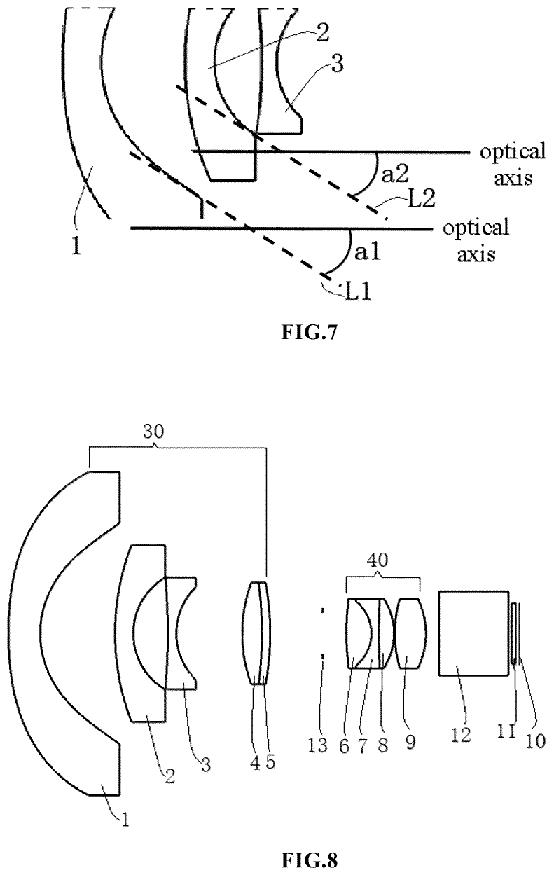

In an embodiment, referring to FIG. 7, in the negative lens group, the lens with a negative focal power has a concave surface closer to the zoom-out side, and an edge tangent of the concave surface forms an angle ranging from 30° to 50° with the optical axis.

Specifically, the lens with a negative focal power may be a biconcave, plano-concave, or convex-concave lens. In the embodiment, the lenses in the negative lens group all have concave surfaces closer to the zoom-out side, and limitations are made to the angle between the edge tangent of the concave surface and the optical axis, thereby improving the manufacturability and yield of the lens. For example, when the lens is being polished by a device, a too small or too large angle between the edge tangent of the concave surface and the optical axis is not conducive to polishing the lens.

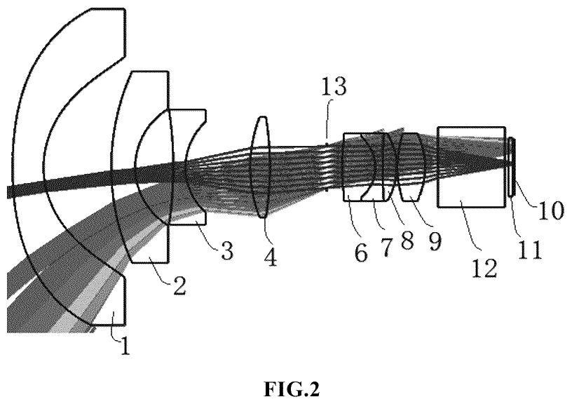

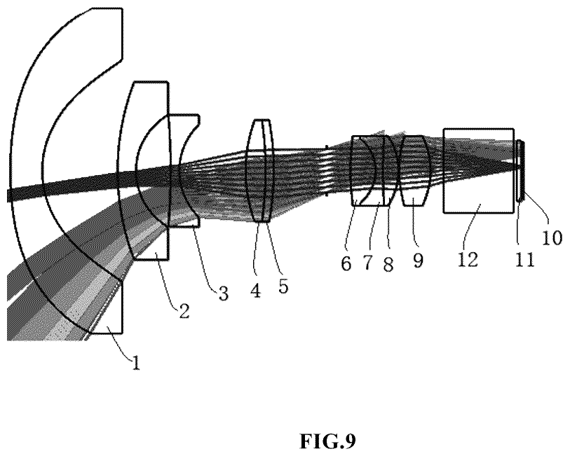

Additionally, the embodiment makes limitations to the angle between the edge tangent of the concave surface of the lenses and the optical axis, to facilitate the bending of light. When the angle between the edge tangent of the concave surface of the lenses in the negative lens group and the optical axis is within this range, it is possible to use fewer lenses to achieve the bending effect of the light. For example, if the angle between the edge tangent of the concave surface of the lenses in the negative lens group and the optical axis is not within this range, more lenses (more than three lenses) would be needed to gradually bend the light to achieve the optical path effect shown in FIGS. 2 and 9. If the angle between the edge tangent of the concave surface of the lenses in the negative lens group and the optical axis is within this range, only three lenses are needed to achieve the optical path effect shown in FIGS. 2 and 9.

Specifically, in the embodiment, “the edge tangent” is defined as a tangent at the point where the part of the concave surface closest to the bottom of the lens connects with the other surface of the lens.

In an embodiment, referring to FIGS. 1, 2 and 8 to 9, from the zoom-in side to the zoom-out side, the negative lens group includes a first lens 1, a second lens 2, and a third lens 3, each having a negative focal power.

In an embodiment, referring to FIGS. 1, 2 and 8 to 9, from the zoom-in side to the zoom-out side, the positive lens group includes a fourth lens 4 with a positive focal power; or, the positive lens group includes a fourth lens 4 and a fifth lens 5, each having a positive focal power.

Referring to FIGS. 1 and 2, in the embodiment, the first lens group 30 includes a negative lens group and a positive lens group, wherein the negative lens group includes three lenses with positive focal powers, and the positive lens includes a single lens with a positive focal power. To ensure that the focal power of the first lens group 30 is negative, there are more lenses with negative focal powers than lenses with positive focal powers in the first lens group 30. The embodiment, by reasonably allocating the focal powers of the lenses in the first lens group 30, the focal power of the first lens group 30 is balanced.

Additionally, in the embodiment, since only one single positive lens is included in the positive lens group, this single positive lens has to provide a greater positive focal power. However, the focal power of a lens is related to the height at which light is incident into the lens: the higher the height, the greater the provided focal power. The embodiment makes limitations the air gap between the third lens 3 and the fourth lens 4, allowing the fourth lens 4 to provide a greater positive focal power to balance the focal power of the first lens group 30 and to better correct aberrations.

Referring to FIGS. 8 and 9, in the embodiment, the first lens group 30 includes a negative lens group and a positive lens group, wherein the negative lens group includes three lenses with positive focal powers, and the positive lens includes two lenses with positive focal powers. To ensure that the focal power of the first lens group 30 is negative, there are more lenses with negative focal powers than lenses with positive focal powers in the first lens group 30. The embodiment, by allocating the focal power of the lenses in the first lens group 30 reasonably, balances the focal power of the first lens group 30.

Additionally, in the embodiment, since the positive lens group includes only two positive lenses, the two positive lenses have to provide a greater positive focal power. However, the focal power of a lens is related to the height at which light is incident into the lens, the higher the height, the greater the provided focal power. The embodiment limits the air gap between the third lens 3 and the fourth lens 4, allowing the fourth lens 4 to provide a greater positive focal power to balance the focal power of the first lens group 30 and to better correct aberrations.

In an optional embodiment, the positive lens group includes a fourth lens 4 and a fifth lens 5, each having a positive focal power and are cemented together. In the embodiment, two lenses with positive focal powers are cemented together, thereby providing a greater positive focal power to balance the first lens group 30. Additionally, by cementing two lenses with positive focal powers together, it is possible to reduce the overall optical length of the first lens group 30.

In an optional embodiment, referring to FIGS. 1 and 2, the refractive index of the fourth lens 4 in the positive lens group ranges from 1.9 to 1.98.

Referring to FIGS. 8 and 9, the refractive index of the fourth lens 4 in the positive lens group ranges from 1.9 to 1.98, and the refractive index of the fifth lens 5 in the positive lens group ranges from 1.75 to 1.8.

In an embodiment, a sum of the focal power of the first lens 1, the second lens 2 and the third lens 3 ranges from −0.16 to 0.14.

In the embodiment, referring to FIGS. 1 and 2, a sum of the focal power of three negative lenses in the negative lens group ranges from −0.16 to −0.14, so that the incident light shrinks from about −56° to 0°, and then expands to about +15°, so as to ensure that the angle of light entering the positive lens group is not too large.

Specifically, by defining the sum of the focal powers of three negative lenses in the negative lens group, in the simulation of the optical projection system, the first lens group 30 of the optical projection system deflects the incident light so that the incident light may enter the first lens 1 at a large negative incident angle (−56°), and is deflected by the first lens 1, the second lens 2 and the third lens 3. When the incident light reaches the third lens 3, the incident angle is essentially 0°, and the third lens 3 expands the light to about +15°, thereby ensuring that the angle at which the light enters the positive lens group is not too large. In the embodiment, by means of the negative lens group, the incident light shrinks from about −56° to 0°, and then expands to about +15°, so as to ensure that the angle of light entering the positive lens group is not too large.

In the embodiment, referring to FIGS. 8 and 9, sum of the focal power of three negative lenses in the negative lens group ranges from −0.15 to −0.13, such that the incident light shrinks from about −56° to 0°, and then expands to about +10°, so as to ensure that the angle of light entering the positive lens group is not too large.

Specifically, by defining the sum of the focal powers of three negative lenses in the negative lens group, in the simulation of the optical projection system, the first lens group 30 of the optical projection system deflects the incident light so that the incident light may enter the first lens 1 at a large negative incident angle (−56°), and is deflected by the first lens 1, the second lens 2 and the third lens 3. When the incident light reaches the third lens 3, the incident angle is essentially 0°, and the third lens 3 expands the light to about +10°, thereby ensuring that the angle at which the light enters the positive lens group is not too large. In the embodiment, by means of the negative lens group, the incident light shrinks from about −56° to 0°, and then expands to about +15°, so as to ensure that the angle of light entering the positive lens group is not too large.

In an optional embodiment, the refractive index of the first lens 1 in the positive lens group ranges from 1.5 to 1.55: the refractive index of the second lens 2 in the positive lens group ranges from 1.68 to 1.72; and the refractive index of the third lens 3 in the positive lens group ranges from 1.55 to 1.6.

In an embodiment, referring to FIGS. 1, 2, and 8 to 9, from the zoom-in side to the zoom-out side, clear aperture of the lenses in the optical projection system gradually decreases.

In the embodiment, from the zoom-in side to the zoom-out side in the optical projection system, the lens closest to the zoom-in side has the largest radial dimension and the lens closest to the zoom-out side has the smallest radial dimension. In the optical lens system, the lenses gradually converge the light.

In an embodiment, referring to FIGS. 1, 2, and 8 to 9, the first lens 1 has a thickness greater than that of the second lens 2, and the second lens 2 has a thickness greater than that of the third lens 3.

In the embodiment, the first lens 1, the second lens 2, and the third lens 3 in the first lens group 30 serve the same function. From the zoom-in side to the zoom-out side, the thickness dimensions of the first lens 1, the second lens 2, and the third lens 3 in the first lens group 30 are scaled down proportionally, which complies with the manufacturing process of the lenses and prevents the creation of a short and thick lens with small clear aperture and large thickness.

In a specific embodiment, from the zoom-in side to the zoom-out side, clear aperture of the lenses in the optical projection system gradually decreases, and the thickness of the first three negative lenses in the optical projection system gradually decreases. Referring to FIGS. 2 and 9, from the zoom-in side to the zoom-out side, the optical projection system converges the light. That is, from the zoom-in side to the zoom-out side, clear aperture of the lenses gradually decreases, that is, the clear aperture of the lenses in the first lens group 30 gradually decreases and the clear aperture of the lenses in the second lens group 40 gradually decreases. A clear aperture of a lens in the first lens group 30 arranged adjacent to the second lens group 40 is greater than a clear aperture of a lens in the second lens group 40 that is closest to the first lens group 30.

In the embodiment, from the zoom-in side to the zoom-out side, clear aperture of the lenses in the first lens group 30 gradually decreases, and from the zoom-in side to the zoom-out side, the thickness of the first three negative lenses in the first lens group 30 gradually decreases, such that the structure of the lens complies with the manufacturing process. In the embodiment, the first lens 1, the second lens 2, and the third lens 3 in the first lens group 30 serve the same function, and from the zoom-in side to the zoom-out side, the thickness dimensions of the first lens 1, the second lens 2, and the third lens 3 in the first lens group 30 are also scaled down proportionally under the premise that the clear aperture of the lenses in the first lens group 30 gradually decreases, which complies with the manufacturing process of the lens and prevents the creation of a short and thick lens with small clear aperture and large thickness.

In an embodiment, referring to FIG. 7, the first lens 1, the second lens 2, and the third lens 3 each has a first surface and a second surface, the second surface is closer to the zoom-out side, and the second surfaces of the first lens 1, the second lens 2 and the third lens 3 are all concave surfaces. An edge tangent of the second surface of the first lens 1 forms an angle of 30° to 40° with the optical axis. An edge tangent of the second surface of the second lens 2 forms an angle of 30° to 40° with the optical axis. An edge tangent of the second surface of the third lens 3 forms an angle of 40° to 50° with the optical axis.

In the embodiment, by defining the angle between the edge tangent of the second surface of the first lens 1 and the optical axis, the angle between the edge tangent of the second surface of the second lens 2 and the optical axis, and the angle between the edge tangent of the second surface of the third lens 3 and the optical axis, it is possible to improve the processability and yield of the first lens 1, the second lens 2, and the third lens 3.

In addition, the embodiment limits the angle between the edge tangent of the concave surfaces of the three negative lenses and the optical axis so as to bend the light. When the angles between the edge tangents of the concave surfaces of the three negative lenses in the negative lens group and the optical axis are all within this range, it is possible to use fewer lenses to realize the bending effect on the light.

In an embodiment, referring to FIGS. 1 and 8, the first lens 1 is an aspherical lens, and the first lens 1 and the second lens 2 are provided therebetween with a fourth air gap greater than 10 mm.

In the embodiment, the first lens 1 is the aspherical lens, which means that in the first lens group 30, the lens farthest from the image source 10 is the aspherical lens, and also, in the first lens group 30, the lens closest to the zoom-in side is the aspherical lens. By setting the first lens 1 as the aspherical lens, it is possible to reduce peripheral aberrations and enhance the imaging quality of the optical projection system.

The embodiment made limitations to the air gap between the first lens 1 and the second lens 2, which further improves the correction effect of the aspherical lens on aberrations for different fields of view. Specifically, since the aspherical lens functions to correct aberrations for different fields of view, it requires a sufficient air distance from the adjacent lens to produce the correction effect. The embodiment made limitations to the air gap between the first lens 1 and the second lens 2, which better corrects the aberrations for different fields of view.

In an embodiment, referring to FIGS. 1, 2, and 8 to 9, from the zoom-in side to the zoom-out side, the second lens group 40 includes a sixth lens 6, a seventh lens 7, an eighth lens 8 and a ninth lens 9, with focal power of the second lens group 40 being in an order of positive, negative, positive, and positive.

In a specific embodiment, the sixth lens 6, the seventh lens 7 and the eighth lens 8 are cemented together to form a triple-cemented lens, and in the triple-cemented lens, a lens with a positive focal power has refractive index smaller than that of a lens with a negative focal power.

In the embodiment, the seventh lens 7 and the eighth lens 8 in the second lens group 40 are cemented together to form the triple-cemented lens, wherein in the second lens group 40, the triple-cemented lens is provided closest to the zoom-in side, and the ninth lens 9 is provided closest to the image source 10, which means that the triple-cemented lens is provided near the stop 13 to further improve the effect of eliminating chromatic aberration.

In an embodiment, the focal powers of the sixth lens 6, the eighth lens 8, and the ninth lens 9 are all positive, and the focal power of the seventh lens 7 is negative, wherein the refractive index of the lens with a positive focal power is less than that of the lens with a negative focal power.

In the embodiment, to ensure that the focal power of the second lens group 40 is positive, there are more lenses with positive focal powers than lenses with negative focal powers in the second lens group 40. Additionally, in the embodiment, the refractive index of lenses with positive focal powers is less than that of lenses with negative focal powers, and the triple-cemented lens with a combination of high and low refractive indices is beneficial for eliminating chromatic aberration. In an optional embodiment, the refractive index of the lens with a positive focal power in the three-cemented lens ranges from 1.48 to 1.6, and the refractive index of the lens with a negative focal power ranges from 1.85 to 1.95.

In an optional embodiment, in the triple-cemented lens, the thickness of the lens with a positive focal power is greater than that of the lens with a negative focal power.

In an embodiment, the ninth lens 9 is an aspherical lens, and the air gap between the triple-cemented lens and the ninth lens 9 is less than 1 mm and greater than 0.1 mm.

In the embodiment, the ninth lens 9 is the aspherical lens, which means that in the second lens group 40, the lens closest to the image source 10 is the aspherical lens, and also, in the second lens group 40, the lens farthest from the zoom-in side is the aspherical lens. By setting the ninth lens 9 as the aspherical lens, it is possible to reduce peripheral aberrations and enhance the imaging quality of the optical projection system.

The embodiment made limitations to the air gap between the triple-cemented lens and the ninth lens 9, which further improves the correction effect of the aspherical lens on aberrations for different fields of view. Specifically, because the aspherical lens functions to correct aberrations for different fields of view, it requires a sufficient air distance from the adjacent lens to produce the correction effect. Therefore, by limiting the air gap between the triple-cemented lens and the ninth lens 9 to be less than 1 mm and greater than 0.1 mm, it is possible to reduce the overall volume of the optical projection system on the one hand, and not affect the aberration correction effect of the aspherical lens on the other hand.

According to a second aspect, an electronic device is provided. The electronic device includes the optical projection system of the first aspect. In the embodiment, the electronic device is a projection device. For example, the projection device may be a projector, or an illuminator.

### Embodiment One

Referring to FIG. 1, from the zoom-in side to the zoom-out side, the optical projection system includes a first lens 1, a second lens 2, a third lens 3, a fourth lens 4, a sixth lens 6, a seventh lens 7, an eighth lens 8, and a ninth lens 9. Specifically, the fourth lens 4 and the sixth lens 6 are provided with a stop 13 therebetween. The sixth lens 6, the seventh lens 7, and the eighth lens 8 are cemented together. The focal power of the optical projection system is in an order of: negative, negative, negative and positive/positive, negative, positive and positive.

In the embodiment, the focal length of the first lens 1 ranges from −37 mm to −35 mm; the focal length of the second lens 2 is from −22 mm to −19 mm; the focal length of the third lens 3 is from −15 mm to −12 mm; the focal length of the fourth lens 4 is from 15 mm to 17 mm; the focal length of the sixth lens 6 is from −21 mm to −19 mm; the focal length of the seventh lens 7 is from −15 mm to −13 mm; the focal length of the eighth lens 8 is from 21 mm to 23 mm; the focal length of the ninth lens 9 is from 10 mm to 12 mm. In the embodiment, the system focal length of the optical projection system is from 2.5 mm to 3 mm; the angle of field of the optical projection system is from 53° to 59°; the diameter of the image circle is from 8.5 mm to 9.1 mm; the F-number of the system is from 1.65 to 1.75. The architecture of the present optical projection system is suitable for a 0.23″ DMD TR 0.5 144% offset design. That is, the embodiment of the present disclosure constructs an optical architecture suitable for a 0.23″ DMD TR 0.5 144% offset by using eight lenses, which reduces the number of lenses used and reduces the volume of the optical projection system compared to the prior art.

Specifically, referring to FIG. 1, the surface close to the zoom-in side in the first lens 1 is a convex surface, and the surface away from the zoom-in side is a concave surface; the surface in the second lens 2 adjacent to the first lens 1 is a convex surface, and the surface adjacent to the third lens 3 is a concave surface; the surface in the third lens 3 adjacent to the second lens 2 is a concave surface, and the surface adjacent to the fourth lens 4 is a concave surface; wherein in the third lens 3, the depression degree of the surface adjacent to the second lens 2 is less than that of the surface adjacent to the fourth lens 4. The surface in the fourth lens 4 arranged adjacent to the third lens 3 is a convex surface, and the surface arranged adjacent to the stop 13 is a convex surface. The surface in the sixth lens 6 arranged adjacent to the stop 13 is a convex surface, and the surface adjacent to the seventh lens 7 is a convex surface. The surface in the seventh lens 7 arranged adjacent to the sixth lens 6 is a concave surface, and the surface arranged adjacent to the eighth lens 8 is a flat surface. The surface in the eighth lens 8 arranged adjacent to the seventh lens 7 is a flat surface, and the surface adjacent to the ninth lens 9 is a convex surface; the surface in the ninth lens 9 arranged adjacent to the eighth lens 8 is a convex surface, and the surface arranged adjacent to the prism 12 is a convex surface.

The specific parameters of each of the above lenses are shown in Table 1 below:

| lens serial | lens | curvature | thickness | refractive | abbe |
|---|---|---|---|---|---|
| number | material | radius mm | mm | index Nd | number Vd |
| 1 | plastic | 51.5 | 4.85 | 1.53 | 55.8 |
| | | 14.1 | 10.6 | | |
| 2 | glass | 35.9 | 3.7 | 1.7 | 41.1 |
| | | 10.6 | 5.9 | | |
| 3 | glass | −60.2 | 1.89 | 1.59 | 68.3 |
| | | 9.5 | 10.1 | | |
| 4 | glass | 21.6 | 3.08 | 1.91 | 35.3 |
| | | −49.1 | 8 | | |
| stop 13 | / | / | 3.3 | / | / |
| 6/7/8 | glass | 32.3 | 5.2 | 1.5 | 81.6 |
| | | −6.2 | 1.16 | 1.9 | 31.3 |
| | | 91.2 | 2.19 | 1.5 | 81.6 |
| | | −10.1 | 0.1 | | |
| 9 | glass | 15.1 | 4.3 | 1.59 | 61.2 |
| | | −11.3 | 2 | | |

In the embodiment, the first lens 1 is an aspherical lens, the ninth lens 9 is an aspherical lens, and the other lenses are spherical lenses. Specifically, the spherical parameters corresponding to the aspherical lens are shown in Table 2:

| serial | | | | | |
|---|---|---|---|---|---|
| number | CONIC | A2 | A3 | A4 | A5 |
| 1 | 2.818 | 8.82e−6 | 4.91e−9 | −8.43e−12 | −1.66e−14 |
| | −0.859 | 1.13e−5 | 1.33e−7 | −5.62e−11 | −1.38e−12 |
| 9 | −2.141 | −8.25e−5 | 2.28e−7 | −1.61e−8 | 2.95e−10 |
| | −1.578 | −3.93e−5 | 5.64e−7 | −3.77e−8 | 5.37e−10 |

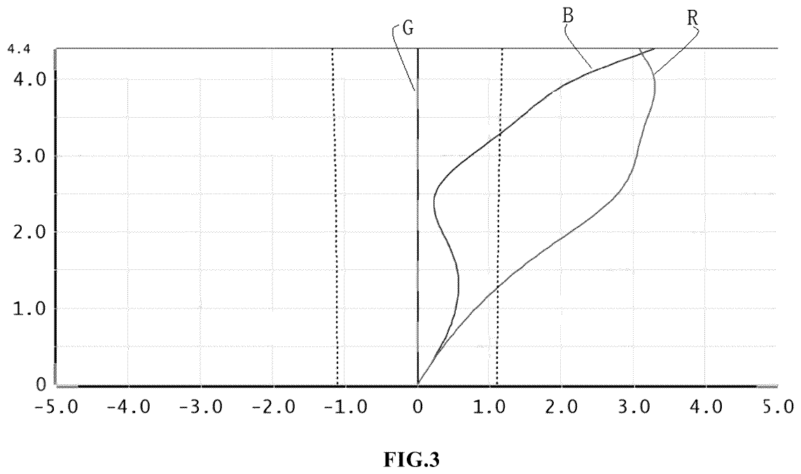

After measurement, the obtained parameters of the various fields of view of the above optical imaging module are shown in FIGS. 3 to 6.

As shown in FIG. 3, it is the chromatic aberration diagram of the optical projection system. It can be seen from the diagram that in the visible spectrum band, the chromatic aberration has a value less than 3.1 μm, and has a high image color reproduction.

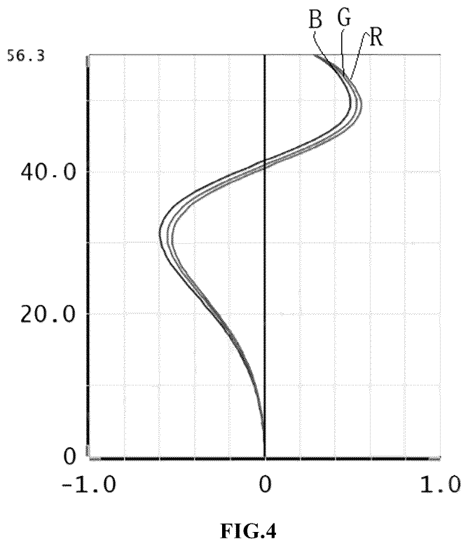

As shown in FIG. 4, it is the distortion value diagram of the optical projection system. It can be seen from the diagram that the distortion value of the optical projection system ranges from +0.6% to −0.6%, which means that the distortion value of the optical projection system is less than 0.6% (it usually needs to be less than <1%). It can be seen that the distortion after imaging by the system in each field of view will also be small, which fully satisfies the requirements of the human eye for distortion.

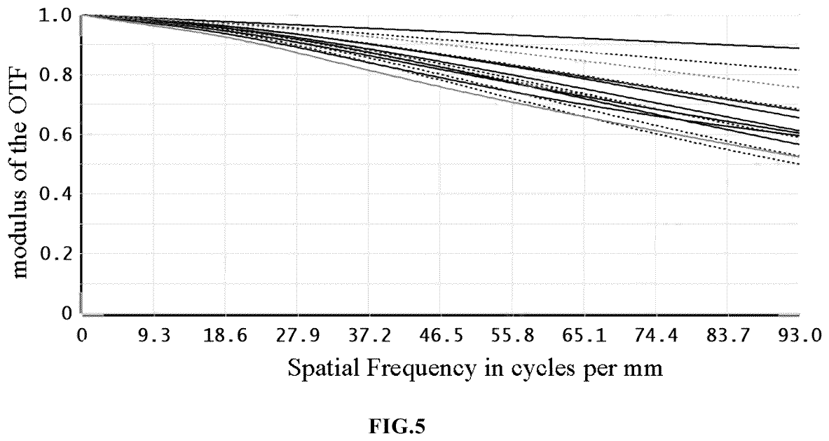

FIG. 5 shows the modulation transfer function (MTF) diagram of the embodiment, wherein the horizontal axis represents spatial frequency (Spatial Frequency in cycles per mm), and the vertical axis represents the modulus of the OTF. As can be seen from the figure that in the spatial frequency of 0 to 93 mm, the modulus value of the OTF may always be kept above 0.5. Generally speaking, the closer the modulus value of the OTF is to 1, the higher the quality of the image. However, due to various factors, there is no situation where the modulus value of the OTF is 1. Generally, when the modulus value of the OTF may be kept above 0.5, it indicates that the image has a very high imaging quality, and an excellent clarity. Therefore, it can be concluded that the optical projection system in the embodiment has a higher imaging quality.

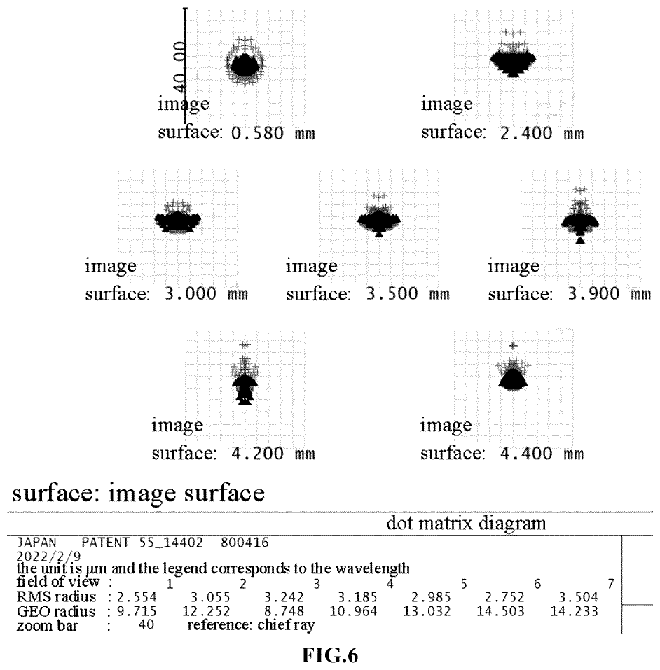

FIG. 6 shows the dot matrix diagram of the embodiment. It can be seen from the figure that the optical projection system meets requirements on clarity. For example, the optical projection system in the embodiment is applied to a 0.23″ DMD TR 0.5 144% offset design, wherein the 0.23″ DMD has a pixel size of 5.4 μm. As can be seen from the RMS radius parameter in the dot matrix diagram that, the RMS radius parameter of each field of view is less than 5.4 μm. The optical projection system of the embodiment has high clarity.

### Embodiment Two

Embodiment Two differs from Embodiment One in that parameters of the curvature radius, thickness, and aspherical lens of each lens are different. In the embodiment, the specific parameters of each lens are shown in Table 3 below:

| lens | | curvature | | | abbe |
|---|---|---|---|---|---|
| serial | lens | radius | thickness | refractive | number |
| number | material | mm | mm | index Nd | Vd |
| 1 | plastic | 70 | 5.255 | 1.53 | 55.8 |
| | | 15.34 | 10.32 | | |
| 2 | glass | 36.32 | 3.48 | 1.7 | 41.1 |
| | | 10.84 | 6.1 | | |
| 3 | glass | −71.14 | 3.03 | 1.59 | 68.3 |
| | | 9.34 | 10.1 | | |
| 4 | glass | 21.97 | 4.77 | 1.91 | 35.3 |
| | | −40 | 10.35 | | |
| 6/7/8 | glass | 31.5 | 4.44 | 1.5 | 81.6 |
| | | −6.28 | 1.36 | 1.9 | 31.3 |
| | | 55.33 | 3.04 | 1.5 | 81.6 |
| | | −9.16 | 0.1 | | |
| 9 | glass | 14.69 | 3.93 | 1.59 | 61.2 |
| | | −15 | 2 | | |

In the embodiment, the first lens 1 is an aspherical lens, the ninth lens 9 is an aspherical lens, and the other lenses are spherical lenses. Specifically, the spherical parameters corresponding to the aspherical lens are shown in Table 4:

| serial | | | | | |
|---|---|---|---|---|---|
| number | CONIC | A2 | A3 | A4 | A5 |
| 1 | 4.027 | 1.01e−5 | 6.24e−9 | −6.71e−12 | −1.68e−14 |
| | −0.936 | 3.95e−6 | 1.45e−7 | −3.32e−11 | −1.36e−12 |
| 9 | −1.899 | −7.56e−5 | 2.47e−7 | −1.73e−8 | 2.84e−10 |
| | −1.406 | −4.44e−5 | 5.76e−7 | −3.67e−8 | 5.66e−10 |

The optical projection system provided by the embodiment is capable of achieving the effect of the optical projection system provided by the embodiment One. In the embodiment, the system focal length of the optical projection system is from 2.5 mm to 3 mm; the angle of field of the optical projection system is from 53° to 59°; the diameter of the image circle is from 8.5 mm to 9.1 mm; the F-number of the system is from 1.65 to 1.75. The present system is suitable for a 0.23″ DMD TR 0.5 144% offset design. That is, the embodiments of the embodiment of the present disclosure constructs an optical architecture suitable for a 0.23″ DMD TR 0.5 144% offset by using eight lenses, which reduces the number of lenses used and reduces the volume of the optical projection system compared to the prior art.

### Embodiment Three

Embodiment Three differs from Embodiment One in that parameters of the curvature radius, thickness, and aspherical lens of each lens are different. In the embodiment, the specific parameters of each lens are shown in Table 5 below:

| lens | | curvature | | | abbe |
|---|---|---|---|---|---|
| serial | lens | radius | thickness | refractive | number |
| number | material | mm | mm | index Nd | Vd |
| 1 | plastic | 60 | 5.23 | 1.53 | 55.8 |
| | | 15.6 | 10.44 | | |
| 2 | glass | 38.62 | 3.9 | 1.7 | 41.1 |
| | | 10.94 | 6.1 | | |
| 3 | glass | −68.1 | 3.01 | 1.59 | 68.3 |
| | | 9.13 | 9.86 | | |
| 4 | glass | 22.5 | 4.77 | 1.91 | 35.3 |
| | | −38 | 10.15 | | |
| 6/7/8 | glass | 31.77 | 4.75 | 1.5 | 81.6 |
| | | −6.32 | 1.1 | 1.9 | 31.3 |
| | | 58.62 | 2.88 | 1.5 | 81.6 |
| | | −9.21 | 0.1 | | |
| 9 | glass | 13.94 | 3.33 | 1.59 | 61.2 |
| | | −15.17 | 2 | | |

In the embodiment, the first lens 1 is an aspherical lens, the ninth lens 9 is an aspherical lens, and the other lenses are spherical lenses. Specifically, the spherical parameters corresponding to the aspherical lens are shown in Table 6:

| serial | | | | | |
|---|---|---|---|---|---|
| number | CONIC | A2 | A3 | A4 | A5 |
| 1 | 4.004 | 9.41e−6 | 5.67e−9 | −6.71e−12 | −1.66e−14 |
| | −0.893 | 5.63e−6 | 1.45e−7 | −3.05e−11 | −1.37e−12 |
| 9 | −1.836 | −7.38e−5 | 2.36e−7 | −1.88−e8 | 2.65e−10 |
| | −1.335 | −4.69e−5 | 5.94e−7 | −3.52e−8 | 5.76e−10 |

The optical projection system provided by the embodiment is capable of achieving the effect of the optical projection system provided by the embodiment One. In the embodiment, the system focal length of the optical projection system is from 2.5 mm to 3 mm; the angle of field of the optical projection system is from 53° to 59°; the diameter of the image circle is from 8.5 mm to 9.1 mm; the F-number of the system is from 1.65 to 1.75. The present system is suitable for a 0.23″ DMD TR 0.5 144% offset design. That is, the embodiments of the embodiment of the present disclosure constructs an optical architecture suitable for a 0.23″ DMD TR 0.5 144% offset by using eight lenses, which reduces the number of lenses used and reduces the volume of the optical projection system compared to the prior art.

### Embodiment Four

Embodiment Four differs from Embodiment One in that parameters of the curvature radius, thickness, and aspherical lens of each lens are different. In the embodiment, the specific parameters of each lens are shown in Table 7 below:

| lens | | curvature | | | abbe |
|---|---|---|---|---|---|
| serial | lens | radius | thickness | refractive | number |
| number | material | mm | mm | index Nd | Vd |
| 1 | plastic | 65 | 5.48 | 1.53 | 55.8 |
| | | 15.9 | 10.51 | | |
| 2 | glass | 37.54 | 4.26 | 1.7 | 41.1 |
| | | 10.68 | 5.92 | | |
| 3 | glass | −67.5 | 2.51 | 1.59 | 68.3 |
| | | 8.99 | 9.5 | | |
| 4 | glass | 23.16 | 4.8 | 1.91 | 35.3 |
| | | −35 | 9.69 | | |
| 6/7/8 | glass | 35.57 | 5.27 | 1.5 | 81.6 |
| | | −6.35 | 1.1 | 1.9 | 31.3 |
| | | 56.82 | 2.46 | 1.5 | 81.6 |
| | | −9.44 | 0.1 | | |
| 9 | glass | 13.5 | 3.16 | 1.59 | 61.2 |
| | | −13.83 | 2 | | |

In the embodiment, the first lens 1 is an aspherical lens, the ninth lens 9 is an aspherical lens, and the other lenses are spherical lenses. Specifically, the spherical parameters corresponding to the aspherical lens are shown in Table 8:

| serial | | | | | |
|---|---|---|---|---|---|
| number | CONIC | A2 | A3 | A4 | A5 |
| 1 | 4.312 | 9.82e−6 | 5.68e−9 | −6.27e−12 | −1.76e−14 |
| | −0.903 | 5.06e−6 | 1.46e−7 | −2.86e−11 | −1.39e−12 |
| 9 | −1.938 | −7.64e−5 | 2.54e−7 | −1.85−e8 | 2.69e−10 |
| | −1.374 | −4.46e−5 | 5.62e−7 | −3.66e−8 | 5.71e−10 |

The optical projection system provided by the embodiment is capable of achieving the effect of the optical projection system provided by the embodiment One. In the embodiment, the system focal length of the optical projection system is from 2.5 mm to 3 mm; the angle of field of the optical projection system is from 53° to 59°; the diameter of the image circle is from 8.5 mm to 9.1 mm; the F-number of the system is from 1.65 to 1.75. The present system is suitable for a 0.23″ DMD TR 0.5 144% offset design. That is, the embodiments of the embodiment of the present disclosure constructs an optical architecture suitable for a 0.23″ DMD TR 0.5 144% offset by using eight lenses, which reduces the number of lenses used and reduces the volume of the optical projection system compared to the prior art.

### Embodiment Five

Embodiment Five differs from Embodiment One in that parameters of the curvature radius, thickness, and aspherical lens of each lens are different. In the embodiment, the specific parameters of each lens are shown in Table 9 below:

| lens | | curvature | | | abbe |
|---|---|---|---|---|---|
| serial | lens | radius | thickness | refractive | number |
| number | material | mm | mm | index Nd | Vd |
| 1 | plastic | 51 | 4.88 | 1.53 | 55.8 |
| | | 14.3 | 10.5 | | |
| 2 | glass | 36.5 | 3.7 | 1.7 | 41.1 |
| | | 10.7 | 5.95 | | |
| 3 | glass | −61.4 | 1.9 | 1.59 | 68.3 |
| | | 9.5 | 10.14 | | |
| 4 | glass | 21.3 | 3.1 | 1.91 | 35.3 |
| | | −54.2 | 11 | | |
| 6/7/8 | glass | 32.6 | 5.25 | 1.5 | 81.6 |
| | | −6.23 | 1.16 | 1.9 | 31.3 |
| | | 91 | 2.2 | 1.5 | 81.6 |
| | | −10.1 | 0.1 | | |
| 9 | glass | 15.2 | 4.34 | 1.59 | 61.2 |
| | | −11.4 | 2 | | |

In the embodiment, the first lens 1 is an aspherical lens, the ninth lens 9 is an aspherical lens, and the other lenses are spherical lenses. Specifically, the spherical parameters corresponding to the aspherical lens are shown in Table 10:

| serial | | | | | |
|---|---|---|---|---|---|
| number | CONIC | A2 | A3 | A4 | A5 |
| 1 | 2.78 | 8.67e−6 | 4.83e−9 | −7.9e−12 | −1.55e−4 |
| | −0.86 | 1.1e−5 | 1.3e−7 | −5.6e−11 | −1.33e−12 |
| 9 | −2.14 | −8.19e−5 | 2.24e−7 | −1.45e−8 | 3.01e−10 |
| | −1.57 | −3.9e−5 | 5.67e−7 | −3.76e−8 | 5.34e−10 |

The optical projection system provided by the embodiment is capable of achieving the effect of the optical projection system provided by the embodiment One. In the embodiment, the system focal length of the optical projection system is from 2.5 mm to 3 mm; the angle of field of the optical projection system is from 53° to 59°; the diameter of the image circle is from 8.5 mm to 9.1 mm; the F-number of the system is from 1.65 to 1.75. The present system is suitable for a 0.23″ DMD TR 0.5 144% offset design. That is, the embodiments of the embodiment of the present disclosure constructs an optical architecture suitable for a 0.23″ DMD TR 0.5 144% offset by using eight lenses, which reduces the number of lenses used and reduces the volume of the optical projection system compared to the prior art.

### Embodiment Six

Embodiment Six differs from Embodiment One in that parameters of the curvature radius, thickness, and aspherical lens of each lens are different. In the embodiment, the specific parameters of each lens are shown in Table 11 below:

| lens | | curvature | | | abbe |
|---|---|---|---|---|---|
| serial | lens | radius | thickness | refractive | number |
| number | material | mm | mm | index Nd | Vd |
| 1 | plastic | 53 | 5.12 | 1.53 | 55.8 |
| | | 14.26 | 10.6 | | |
| 2 | glass | 36.55 | 3.74 | 1.7 | 41.1 |
| | | 10.75 | 6.01 | | |
| 3 | glass | −59.37 | 1.99 | 1.59 | 68.3 |
| | | 9.5 | 10.16 | | |
| 4 | glass | 24.9 | 3.2 | 1.91 | 35.3 |
| | | −37.54 | 9.02 | | |
| 6/7/8 | glass | 32.5 | 5.44 | 1.5 | 81.6 |
| | | −6.35 | 1.12 | 1.9 | 31.3 |
| | | 70.14 | 2.19 | 1.5 | 81.6 |
| | | −10.1 | 0.1 | | |
| 9 | glass | 15.2 | 4.32 | 1.59 | 61.2 |
| | | −11.4 | 2 | | |

In the embodiment, the first lens 1 is an aspherical lens, the ninth lens 9 is an aspherical lens, and the other lenses are spherical lenses. Specifically, the spherical parameters corresponding to the aspherical lens are shown in Table 12:

| serial | | | | | |
|---|---|---|---|---|---|
| number | CONIC | A2 | A3 | A4 | A5 |
| 1 | 2.795 | 9.1e−6 | 4.92e−9 | −8.03e−12 | −1.54e−14 |
| | −0.89 | 1.04e−5 | 1.23e−7 | −5.7e−11 | −1.33e−12 |
| 9 | −2.063 | −8.015e−5 | 2.22e−7 | −1.59e−8 | 2.98e−10 |
| | −1.57 | −3.92e−5 | 5.8e−7 | −3.73e−8 | 5.38e−10 |

The optical projection system provided by the embodiment is capable of achieving the effect of the optical projection system provided by the embodiment One. In the embodiment, the system focal length of the optical projection system is from 2.5 mm to 3 mm; the angle of field of the optical projection system is from 53° to 59°; the diameter of the image circle is from 8.5 mm to 9.1 mm; the F-number of the system is from 1.65 to 1.75. The present system is suitable for a 0.23″ DMD TR 0.5 144% offset design. That is, the embodiments of the embodiment of the present disclosure constructs an optical architecture suitable for a 0.23″ DMD TR 0.5 144% offset by using eight lenses, which reduces the number of lenses used and reduces the volume of the optical projection system compared to the prior art.

### Embodiment Seven

Embodiment Seven differs from Embodiment One in that parameters of the curvature radius, thickness, and aspherical lens of each lens are different. In the embodiment, the specific parameters of each lens are shown in Table 13 below:

| lens | | curvature | | | abbe |
|---|---|---|---|---|---|
| serial | lens | radius | thickness | refractive | number |
| number | material | mm | mm | index Nd | Vd |
| 1 | plastic | 52.9 | 2.07 | 1.53 | 55.8 |
| | | 14.34 | 10.49 | | |
| 2 | glass | 38 | 3.71 | 1.7 | 41.1 |
| | | 10.88 | 5.97 | | |
| 3 | glass | −62.77 | 1.82 | 1.59 | 68.3 |
| | | 9.49 | 10.41 | | |
| 4 | glass | 25 | 2.58 | 1.91 | 35.3 |
| | | −38.5 | 11.1 | | |
| 6/7/8 | glass | 32.5 | 5.45 | 1.5 | 81.6 |
| | | −6.36 | 1.15 | 1.9 | 31.3 |
| | | 70.2 | 2.23 | 1.5 | 81.6 |
| | | −10.03 | 0.1 | | |
| 9 | glass | 15.2 | 4.38 | 1.59 | 61.2 |
| | | −11.4 | 2 | | |

In the embodiment, the first lens 1 is an aspherical lens, the ninth lens 9 is an aspherical lens, and the other lenses are spherical lenses. Specifically, the spherical parameters corresponding to the aspherical lens are shown in Table 14:

| serial | | | | | |
|---|---|---|---|---|---|
| number | CONIC | A2 | A3 | A4 | A5 |
| 1 | 2.784 | 8.99e−6 | 4.77e−9 | −7.949e−12 | −1.506e−14 |
| | −0.866 | 1.035e−5 | 1.3e−7 | −5.612e−11 | −1.33e−12 |
| 9 | −2.098 | −8.122e−5 | 2.003e−7 | −1.597e−8 | 3.06e−10 |
| | −1.581 | −3.892e−5 | 6.127e−7 | −3.714e−8 | 5.328e−10 |

The optical projection system provided by the embodiment is capable of achieving the effect of the optical projection system provided by the embodiment One. In the embodiment, the system focal length of the optical projection system is from 2.5 mm to 3 mm; the angle of field of the optical projection system is from 53° to 59°; the diameter of the image circle is from 8.5 mm to 9.1 mm; the F-number of the system is from 1.65 to 1.75. The present system is suitable for a 0.23″ DMD TR 0.5 144% offset design. That is, the embodiments of the embodiment of the present disclosure constructs an optical architecture suitable for a 0.23″ DMD TR 0.5 144% offset by using eight lenses, which reduces the number of lenses used and reduces the volume of the optical projection system compared to the prior art.

### Embodiment Eight

Embodiment Eight differs from Embodiment One in that parameters of the curvature radius, thickness, and aspherical lens of each lens are different. In the embodiment, the specific parameters of each lens are shown in Table 15 below:

| lens | | curvature | | | abbe |
|---|---|---|---|---|---|
| serial | lens | radius | thickness | refractive | number |
| number | material | mm | mm | index Nd | Vd |
| 1 | plastic | 53.25 | 4.94 | 1.53 | 55.8 |
| | | 14.41 | 10.42 | | |
| 2 | glass | 36 | 36.12 | 1.7 | 41.1 |
| | | 11.14 | 6.06 | | |
| 3 | glass | −63.64 | 1.898 | 1.59 | 68.3 |
| | | 9.46 | 10.22 | | |
| 4 | glass | 26 | 3.25 | 1.91 | 35.3 |
| | | −38.2 | 11.3 | | |
| 6/7/8 | glass | 32.78 | 5.64 | 1.5 | 81.6 |
| | | −6.39 | 1.135 | 1.9 | 31.3 |
| | | 70 | 2.205 | 1.5 | 81.6 |
| | | −10.35 | 0.1 | | |
| 9 | glass | 13.886 | 4.589 | 1.59 | 61.2 |
| | | −11.73 | 2 | | |

In the embodiment, the first lens 1 is an aspherical lens, the ninth lens 9 is an aspherical lens, and the other lenses are spherical lenses. Specifically, the spherical parameters corresponding to the aspherical lens are shown in Table 16:

| serial | | | | | |
|---|---|---|---|---|---|
| number | CONIC | A2 | A3 | A4 | A5 |
| 1 | 2.735 | 8.97e−6 | 4.68e−9 | −7.67e−12 | −1.486e−14 |
| | −0.872 | 9.88e−6 | 1.303e−7 | −5.51e−11 | −1.33e−12 |
| 9 | −2.268 | −8.54e−5 | 2.28e−7 | −1.55e−8 | 2.976e−0 |
| | −1.545 | −4.11e−5 | 5.36e−7 | −3.8e−8 | 5.27e−10 |

The optical projection system provided by the embodiment is capable of achieving the effect of the optical projection system provided by the embodiment One. In the embodiment, the system focal length of the optical projection system is from 2.5 mm to 3 mm; the angle of field of the optical projection system is from 53° to 59°; the diameter of the image circle is from 8.5 mm to 9.1 mm; the F-number of the system is from 1.65 to 1.75. The present system is suitable for a 0.23″ DMD TR 0.5 144% offset design. That is, the embodiments of the embodiment of the present disclosure constructs an optical architecture suitable for a 0.23″ DMD TR 0.5 144% offset by using eight lenses, which reduces the number of lenses used and reduces the volume of the optical projection system compared to the prior art.

### Embodiment Nine

In a specific embodiment, referring to FIG. 8, from the zoom-in side to the zoom-out side, the optical projection system includes a first lens 1, a second lens 2, a third lens 3, a fourth lens 4, a fifth lens 5, a sixth lens 6, a seventh lens 7, an eighth lens 8, and a ninth lens 9. Specifically, the fifth lens 5 and the sixth lens 6 are provided with a stop 13 therebetween. The sixth lens 6, the seventh lens 7, and the eighth lens 8 are cemented together. The focal power of the optical projection system is in an order of: negative, negative, negative, positive and positive/positive, negative, positive and positive

In the embodiment, the focal length of the first lens 1 ranges from −36 mm to −34 mm; the focal length of the second lens 2 is from −20 mm to −18 mm; the focal length of the third lens 3 is from −16 mm to −14 mm; the focal length of the fourth lens 4 is from 22 mm to 24 mm; the focal length of the fifth lens 5 is from 46 mm to 48 mm; the focal length of the sixth lens 6 is from −20 mm to −18 mm; the focal length of the seventh lens 7 is from −16 mm to −14 mm; the focal length of the eighth lens 8 is from 22 mm to 24 mm; the focal length of the ninth lens 9 is from 11 mm to 13 mm. In the embodiment, the system focal length of the optical projection system is from 2.5 mm to 3 mm; the angle of field of the optical projection system is from 53° to 59°; the diameter of the image circle is from 8.5 mm to 9.1 mm; the F-number of the system is from 1.65 to 1.75. The present system is suitable for a 0.23″ DMD TR 0.5 144% offset design. That is, the embodiment of the present disclosure constructs an optical architecture suitable for a 0.23″ DMD TR 0.5 144% offset by using nine lenses, which reduces the number of lenses used and reduces the volume of the optical projection system compared to the prior art.

Specifically, referring to FIG. 8, the surface close to the zoom-in side in the first lens 1 is a convex surface, and the surface away from the zoom-in side is a concave surface; the surface in the second lens 2 adjacent to the first lens 1 is a convex surface, and the surface adjacent to the third lens 3 is a concave surface; the surface in the third lens 3 adjacent to the second lens 2 is a concave surface, and the surface adjacent to the fourth lens 4 is a concave surface; wherein in the third lens 3, the depression degree of the surface adjacent to the second lens 2 is less than that of the surface adjacent to the fourth lens 4. The surface in the fourth lens 4 arranged adjacent to the third lens 3 is a convex surface, and the surface arranged adjacent to the fifth lens 5 is a convex surface. The surface in the fifth lens 5 arranged adjacent to the fourth lens 4 is a concave surface, and the surface arranged adjacent to the stop 13 is a convex surface; the surface in the sixth lens 6 arranged adjacent to the stop 13 is a convex surface, and the surface adjacent to the seventh lens 7 is a convex surface. The surface in the seventh lens 7 arranged adjacent to the sixth lens 6 is a concave surface, and the surface arranged adjacent to the eighth lens 8 is a flat surface. The surface in the eighth lens 8 arranged adjacent to the seventh lens 7 is a flat surface, and the surface adjacent to the ninth lens 9 is a convex surface; the surface in the ninth lens 9 arranged adjacent to the eighth lens 8 is a convex surface, and the surface arranged adjacent to the prism 12 is a convex surface.

The specific parameters of each of the above lenses are shown in Table 17 below:

| lens | | curvature | | | abbe |
|---|---|---|---|---|---|
| serial | lens | radius | thickness | refractive | number |
| number | material | mm | mm | index Nd | Vd |
| 1 | plastic | 51.4 | 4.8 | 1.53 | 55.8 |
| | | 13.9 | 11.3 | | |
| 2 | glass | 37.2 | 2.7 | 1.7 | 41.1 |
| | | 9.8 | 5.2 | | |
| 3 | glass | −101.9 | 1.3 | 1.59 | 68.3 |
| | | 9.78 | 9.9 | | |
| 4/5 | glass | 22.1 | 3 | 1.91 | 35.3 |
| | | −54.9 | 1.2 | | |
| | | −42.6 | 8 | 17.8 | 25.7 |
| stop 13 | / | / | 3.6 | / | / |
| 6/7/8 | glass | 35.2 | 3.8 | 1.5 | 81.6 |
| | | −6.2 | 1.1 | 1.9 | 31.3 |
| | | 84.2 | 2.3 | 1.5 | 81.6 |
| | | −9.6 | 0.1 | | |
| 9 | glass | 15.8 | 4.7 | 1.59 | 61.2 |
| | | −11.2 | 2 | | |

In the embodiment, the first lens 1 is an aspherical lens, the ninth lens 9 is an aspherical lens, and the other lenses are spherical lenses. Specifically, the spherical parameters corresponding to the aspherical lens are shown in Table 18.

| serial | | | | | |
|---|---|---|---|---|---|
| number | CONIC | A2 | A3 | A4 | A5 |
| 1 | 2.837 | 9.89e−6 | 3.05e−9 | −1.1e−11 | −5.25e−15 |
| | −0.851 | 1.04e−5 | 1.23e−7 | −5.1e−11 | −1.3e−12 |
| 9 | −2.166 | −8.3e−5 | 1.76e−7 | −1.84e−8 | 3.6e−10 |
| | −1.561 | −3.8e−5 | 6.3e−7 | −3.87e−8 | 4.86e−10 |

In the embodiment, the system is suitable for a 0.23″ DMD TR 0.5 144% offset design. The optical projection system may achieve the following effects: a projection ratio of 0.5, a focal length of the optical system of 2.5 mm to 3 mm, an angle of field of 53° to 59°, a diameter of the image circle of 8.5 mm to 9.1 mm, and a F-number of the system of 1.65 to 1.75.

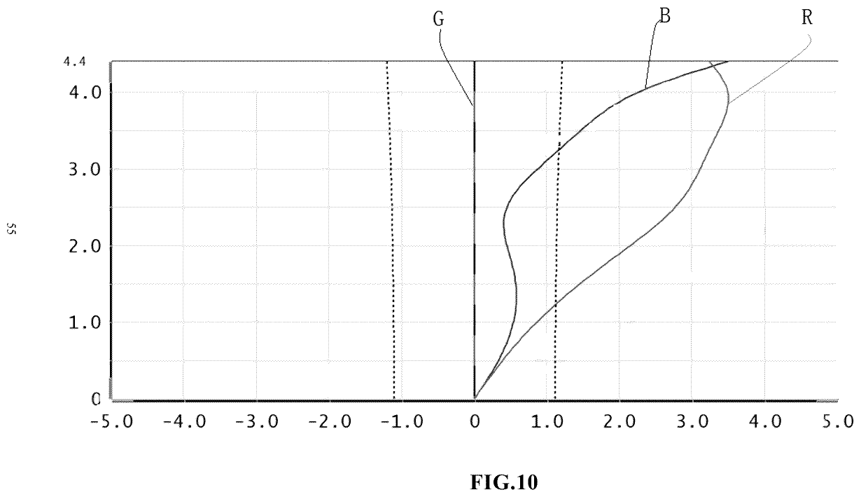

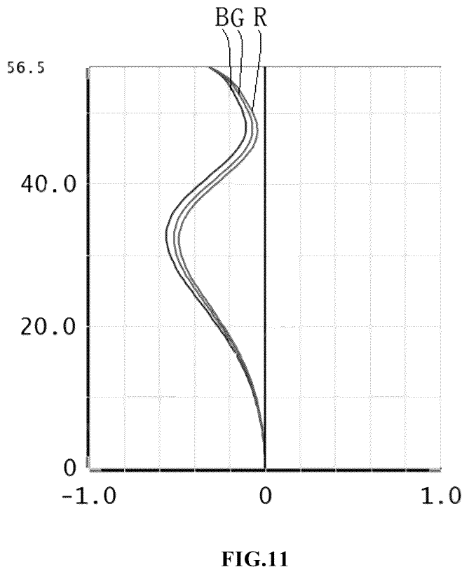

After measurement, the obtained parameters of the various fields of view of the above optical imaging module are shown in FIGS. 10 to 13.

As shown in FIG. 10, it is the chromatic aberration diagram of the optical projection system. It can be seen from the diagram that in the visible spectrum band, the chromatic aberration has a value less than 3.5 μm, and has a high image color reproduction.

As shown in FIG. 11, it is the distortion value diagram of the optical projection system. It can be seen from the diagram that the distortion value of the optical projection system ranges from 0% to −0.6% (it usually needs to be less than <1%). It can be seen that the distortion after imaging by the system in each field of view will also be small, which fully satisfies the requirements of the human eye for distortion.

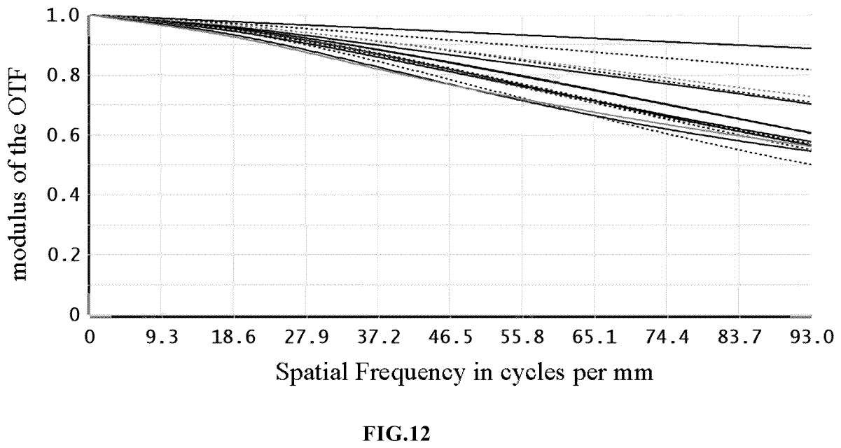

FIG. 12 shows the modulation transfer function (MTF) diagram of the embodiment, wherein the horizontal axis represents spatial frequency (Spatial Frequency in cycles per mm), and the vertical axis represents the modulus of the OTF. As can be seen from the figure that in the spatial frequency of 0 to 93 mm, the modulus value of the OTF may always be kept above 0.5. Generally speaking, the closer the modulus value of the OTF is to 1, the higher the quality of the image. However, due to various factors, there is no situation where the modulus value of the OTF is 1. Generally, when the modulus value of the OTF may be kept above 0.5, it indicates that the image has a very high imaging quality, and an excellent clarity. Therefore, it can be concluded that the optical projection system in the embodiment has a higher imaging quality.

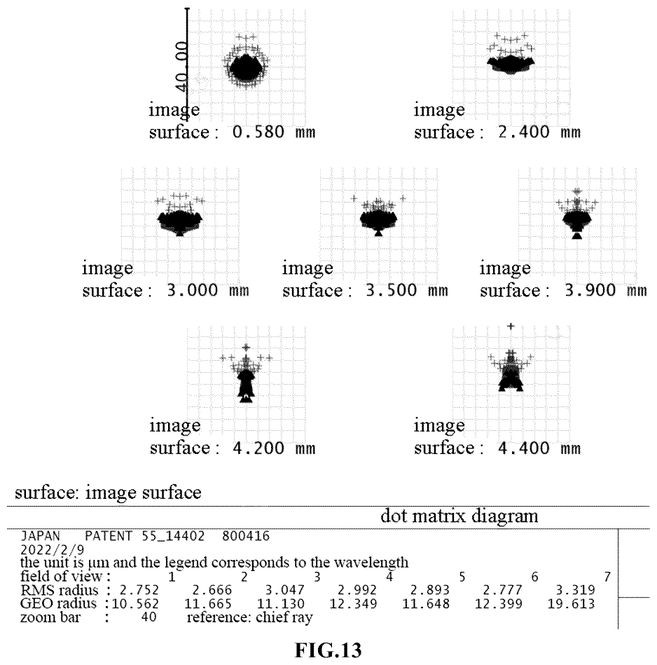

FIG. 13 shows the dot matrix diagram of the embodiment. It can be seen from the figure that the optical projection system meets requirements on clarity. For example, the optical projection system in the embodiment is applied to a 0.23″ DMD TR 0.5 144% offset design, wherein the 0.23″ DMD has a pixel size of 5.4 μm. As can be seen from the RMS radius parameter in the dot matrix diagram that, the RMS radius parameter of each field of view is less than 5.4 μm. The optical projection system of the embodiment has high clarity.

### Embodiment Ten

Embodiment Ten differs from Embodiment Nine in that parameters of the curvature radius, thickness, and aspherical lens of each lens are different. In the embodiment, the specific narameters of each lens are shown in Table 19 below.

| lens | | curvature | | | abbe |
|---|---|---|---|---|---|
| serial | lens | radius | thickness | refractive | number |
| number | material | mm | mm | index Nd | Vd |
| 1 | plastic | 49.9 | 4.9 | 1.53 | 55.8 |
| | | 13.9 | 11.9 | | |
| 2 | glass | 44.6 | 1.75 | 1.7 | 41.1 |
| | | 9.9 | 5.2 | | |
| 3 | glass | −260 | 1.6 | 1.59 | 68.3 |
| | | 9.58 | 10.03 | | |
| 4/5 | glass | 22.2 | 3.8 | 1.91 | 35.3 |
| | | −30 | 0.91 | | |
| | | −42.3 | 12.0 | 17.8 | 25.7 |
| 6/7/8 | glass | 34.0 | 3.53 | 1.5 | 81.6 |
| | | −6.2 | 1.2 | 1.9 | 31.3 |
| | | 90.0 | 2.21 | 1.5 | 81.6 |
| | | −9.9 | 0.1 | | |
| 9 | glass | 15.7 | 3.95 | 1.59 | 61.2 |
| | | −11.6 | 2 | | |

In the embodiment, the first lens 1 is an aspherical lens, the ninth lens 9 is an aspherical lens, and the other lenses are spherical lenses. Specifically, the spherical parameters corresponding to the aspherical lens are shown in Table 20:

| serial | | | | | |
|---|---|---|---|---|---|
| number | CONIC | A2 | A3 | A4 | A5 |
| 1 | 2.929 | 1.0e−5 | 4.1e−9 | −1.2e−11 | −1.0e−14 |
| | −0.842 | 1.17e−5 | 1.2e−7 | −5.6e−11 | −1.3e−12 |
| 9 | −1.959 | −7.9e−5 | 2.3e−7 | −1.9e−8 | 3.5e−10 |
| | −1.545 | −3.8e−5 | 6.3e−7 | −3.8e−8 | 4.97e−10 |

The optical projection system provided by the embodiment is capable of achieving the effect of the optical projection system provided by the embodiment Nine. In the embodiment, the system focal length of the optical projection system is from 2.5 mm to 3 mm; the angle of field of the optical projection system is from 53° to 59°; the diameter of the image circle is from 8.5 mm to 9.1 mm; the F-number of the system is from 1.65 to 1.75. The present system is suitable for a 0.23″ DMD TR 0.5 144% offset design. That is, the embodiments of the present disclosure constructs an optical architecture suitable for a 0.23″ DMD TR 0.5 144% offset by using nine lenses, which reduces the number of lenses used and reduces the volume of the optical projection system compared to the prior art.

### Embodiment Eleven

Embodiment Eleven differs from Embodiment Nine in that parameters of the curvature radius, thickness, and aspherical lens of each lens are different. In the embodiment, the specific parameters of each lens are shown in Table 21 below:

| lens | | curvature | | | abbe |
|---|---|---|---|---|---|
| serial | lens | radius | thickness | refractive | number |
| number | material | mm | mm | index Nd | Vd |
| 1 | plastic | 51.76 | 4.9 | 1.53 | 55.8 |
| | | 14.11 | 12.7 | | |
| 2 | glass | 43.23 | 1.47 | 1.7 | 41.1 |
| | | 9.6 | 5.1 | | |
| 3 | glass | −300 | 1.5 | 1.59 | 68.3 |
| | | 9.4 | 9.68 | | |
| 4/5 | glass | 22.81 | 4.73 | 1.91 | 35.3 |
| | | −25 | 0.92 | | |
| | | −37.52 | 11.62 | 17.8 | 25.7 |
| 6/7/8 | glass | 29.04 | 3.87 | 1.5 | 81.6 |
| | | −6.3 | 1.3 | 1.9 | 31.3 |
| | | 80 | 2.13 | 1.5 | 81.6 |
| | | −10.5 | 0.1 | | |
| 9 | glass | 15.76 | 3.2 | 1.59 | 61.2 |
| | | −11.74 | 2 | | |

In the embodiment, the first lens 1 is an aspherical lens, the ninth lens 9 is an aspherical lens, and the other lenses are spherical lenses. Specifically, the spherical parameters corresponding to the aspherical lens are shown in Table 22:

| serial | | | | | |
|---|---|---|---|---|---|
| number | CONIC | A2 | A3 | A4 | A5 |
| 1 | 3.006 | 8.96e−6 | 7.81e−9 | −1.04e−11 | −2.34e−14 |
| | −0.856 | 6.48e−6 | 1.52e−7 | −3.13e−11 | −1.48e−12 |
| 10 | −1.988 | −7.96e−5 | 7.76e−8 | −2.35e−8 | 3.81e−10 |
| | −1.557 | −4.37e−5 | 3.52e−7 | −3.86e−8 | 4.67e−10 |

The optical projection system provided by the embodiment is capable of achieving the effect of the optical projection system provided by the embodiment Nine. In the embodiment, the system focal length of the optical projection system is from 2.5 mm to 3 mm; the angle of field of the optical projection system is from 53° to 59°; the diameter of the image circle is from 8.5 mm to 9.1 mm; the F-number of the system is from 1.65 to 1.75. The present system is suitable for a 0.23″ DMD TR 0.5 144% offset design. That is, the embodiments of the present disclosure constructs an optical architecture suitable for a 0.23″ DMD TR 0.5 144% offset by using nine lenses, which reduces the number of lenses used and reduces the volume of the optical projection system compared to the prior art.

### Embodiment Twelve

Embodiment Twelve differs from Embodiment Nine in that parameters of the curvature radius, thickness, and aspherical lens of each lens are different. In the embodiment, the specific parameters of each lens are shown in Table 23 below:

| lens | | curvature | | | abbe |
|---|---|---|---|---|---|
| serial | lens | radius | thickness | refractive | number |
| number | material | mm | mm | index Nd | Vd |
| 1 | plastic | 55.1 | 4.95 | 1.53 | 55.8 |
| | | 14.74 | 13.4 | | |
| 2 | glass | 42.6 | 1.38 | 1.7 | 41.1 |
| | | 9.2 | 4.87 | | |
| 3 | glass | −500 | 1.45 | 1.59 | 68.3 |
| | | 9.1 | 9.8 | | |
| 4/5 | glass | 23.1 | 4.6 | 1.91 | 35.3 |
| | | −20 | 0.87 | | |
| | | −35.97 | 11.37 | 17.8 | 25.7 |
| 6/7/8 | glass | 27.1 | 3.86 | 1.5 | 81.6 |
| | | −6.4 | 1.3 | 1.9 | 31.3 |
| | | 50 | 2.2 | 1.5 | 81.6 |
| | | −10.6 | 0.1 | | |
| 9 | glass | 15.8 | 3.15 | 1.59 | 61.2 |
| | | −11.8 | 2 | | |

In the embodiment, the first lens 1 is an aspherical lens, the ninth lens 9 is an aspherical lens, and the other lenses are spherical lenses. Specifically, the spherical parameters corresponding to the aspherical lens are shown in Table 24:

| serial | | | | | |
|---|---|---|---|---|---|
| number | CONIC | A2 | A3 | A4 | A5 |
| 1 | 3.354 | 8.75e−6 | 8.66e−9 | −8.27e−12 | −2.55e−14 |
| | −0.886 | 2.61e−6 | 1.63e−7 | −9.15e−12 | −1.31e−12 |
| 10 | −1.984 | −8.06e−5 | 2.98e−8 | −2.46e−8 | 3.82e−10 |
| | −1.534 | −4.67e−5 | 2.69e−7 | −3.83e−8 | 4.48e−10 |

The optical projection system provided by the embodiment is capable of achieving the effect of the optical projection system provided by the embodiment Nine. In the embodiment, the system focal length of the optical projection system is from 2.5 mm to 3 mm; the angle of field of the optical projection system is from 53° to 59°; the diameter of the image circle is from 8.5 mm to 9.1 mm; the F-number of the system is from 1.65 to 1.75. The present system is suitable for a 0.23″ DMD TR 0.5 144% offset design. That is, the embodiments of the present disclosure constructs an optical architecture suitable for a 0.23″ DMD TR 0.5 144% offset by using nine lenses, which reduces the number of lenses used and reduces the volume of the optical projection system compared to the prior art.

### Embodiment Thirteen

Embodiment Thirteen differs from Embodiment Nine in that parameters of the curvature radius, thickness, and aspherical lens of each lens are different. In the embodiment, the specific parameters of each lens are shown in Table 25 below:

| lens | | curvature | | | abbe |
|---|---|---|---|---|---|
| serial | lens | radius | thickness | refractive | number |
| number | material | mm | mm | index Nd | Vd |
| 1 | plastic | 51.5 | 4.8 | 1.53 | 55.8 |
| | | 13.98 | 11.35 | | |
| 2 | glass | 37.38 | 2.77 | 1.7 | 41.1 |
| | | 9.83 | 5.25 | | |
| 3 | glass | −99 | 1.37 | 1.59 | 68.3 |
| | | 9.78 | 9.98 | | |
| 4/5 | glass | 21.19 | 2.78 | 1.91 | 35.3 |
| | | −53 | 1.12 | | |
| | | −42.67 | 7.86 | 17.8 | 25.7 |
| 6/7/8 | glass | 35.3 | 3.56 | 1.5 | 81.6 |
| | | −6.03 | 3.85 | 1.9 | 31.3 |
| | | 83.3 | 1.13 | 1.5 | 81.6 |
| | | −9.68 | 2.34 | | |
| 9 | glass | 15.82 | 0.1 | 1.59 | 61.2 |
| | | −11.28 | 4.76 | | |

In the embodiment, the first lens 1 is an aspherical lens, the ninth lens 9 is an aspherical lens, and the other lenses are spherical lenses. Specifically, the spherical parameters corresponding to the aspherical lens are shown in Table 26:

| serial | | | | | |
|---|---|---|---|---|---|
| number | CONIC | A2 | A3 | A4 | A5 |
| 1 | 2.936 | 9.91e−6 | 3.09e−9 | −1.096e−11 | −5.38e−15 |
| | −0.85 | 1.04e−5 | 1.23e−7 | −5.14e−11 | −1.31e−12 |
| 9 | −2.18 | −8.35e−5 | 1.77e−7 | −1.82e−8 | 3.65e−10 |
| | −1.56 | −3.85e−5 | 6.35e−7 | −3.87e−8 | 4.88e−10 |

The optical projection system provided by the embodiment is capable of achieving the effect of the optical projection system provided by the embodiment Nine. In the embodiment, the system focal length of the optical projection system is from 2.5 mm to 3 mm; the angle of field of the optical projection system is from 53° to 59°; the diameter of the image circle is from 8.5 mm to 9.1 mm; the F-number of the system is from 1.65 to 1.75. The present system is suitable for a 0.23″ DMD TR 0.5 144% offset design. That is, the embodiments of the present disclosure constructs an optical architecture suitable for a 0.23″ DMD TR 0.5 144% offset by using nine lenses, which reduces the number of lenses used and reduces the volume of the optical projection system compared to the prior art.

### Embodiment Fourteen

Embodiment Fourteen differs from Embodiment Nine in that parameters of the curvature radius, thickness, and aspherical lens of each lens are different. In the embodiment, the specific parameters of each lens are shown in Table 27 below:

| lens | | curvature | | | abbe |
|---|---|---|---|---|---|
| serial | lens | radius | thickness | refractive | number |
| number | material | mm | mm | index Nd | Vd |
| 1 | plastic | 51.55 | 4.92 | 1.53 | 55.8 |
| | | 14.03 | 11.41 | | |
| 2 | glass | 38.93 | 2.71 | 1.7 | 41.1 |
| | | 9.97 | 5.34 | | |
| 3 | glass | −97 | 1.617 | 1.59 | 68.3 |
| | | 9.8 | 9.99 | | |
| 4/5 | glass | 21.14 | 2.45 | 1.91 | 35.3 |
| | | −57 | 1.234 | | |
| | | −42.5 | 8.01 | 17.8 | 25.7 |
| 6/7/8 | glass | 35.56 | 3.66 | 1.5 | 81.6 |
| | | −6.2 | 4.01 | 1.9 | 31.3 |
| | | 102.4 | 1.25 | 1.5 | 81.6 |
| | | −9.68 | 0.1 | | |
| 9 | glass | 15.88 | 4.66 | 1.59 | 61.2 |
| | | −11.3 | 2 | | |

In the embodiment, the first lens 1 is an aspherical lens, the ninth lens 9 is an aspherical lens, and the other lenses are spherical lenses. Specifically, the spherical parameters corresponding to the aspherical lens are shown in Table 28:

| serial | | | | | |
|---|---|---|---|---|---|
| number | CONIC | A2 | A3 | A4 | A5 |
| 1 | 2.83 | 9.85e−6 | 3.14e−9 | −1.02e−11 | −5.59e−15 |
| | −0.85 | 1.05e−5 | 1.24e−7 | −5.22e−11 | −1.32e−12 |
| 9 | −2.075 | −8.12e−5 | 1.38e−7 | −1.81e−8 | 3.75e−0 |
| | −1.56 | −3.82e−5 | 6.67e−7 | −3.89e−8 | 4.78e−10 |

The optical projection system provided by the embodiment is capable of achieving the effect of the optical projection system provided by the embodiment Nine. In the embodiment, the system focal length of the optical projection system is from 2.5 mm to 3 mm; the angle of field of the optical projection system is from 53° to 59°; the diameter of the image circle is from 8.5 mm to 9.1 mm; the F-number of the system is from 1.65 to 1.75. The present system is suitable for a 0.23″ DMD TR 0.5 144% offset design. That is, the embodiments of the present disclosure constructs an optical architecture suitable for a 0.23″ DMD TR 0.5 144% offset by using nine lenses, which reduces the number of lenses used and reduces the volume of the optical projection system compared to the prior art.

### Embodiment Fifteen

Embodiment Fifteen differs from Embodiment Nine in that parameters of the curvature radius, thickness, and aspherical lens of each lens are different. In the embodiment, the specific parameters of each lens are shown in Table 29 below:

| lens | | curvature | | | abbe |
|---|---|---|---|---|---|
| serial | lens | radius | thickness | refractive | number |
| number | material | mm | mm | index Nd | Vd |
| 1 | plastic | 51.47 | 4.94 | 1.53 | 55.8 |
| | | 14.03 | 11.4 | | |
| 2 | glass | 38.69 | 2.74 | 1.7 | 41.1 |
| | | 9.97 | 5.43 | | |
| 3 | glass | −95 | 1.66 | 1.59 | 68.3 |
| | | 9.79 | 9.95 | | |
| 4/5 | glass | 22.14 | 2.38 | 1.91 | 35.3 |
| | | −58 | 1.18 | | |
| | | −42.5 | 11.6 | 17.8 | 25.7 |
| 6/7/8 | glass | 35.56 | 4.15 | 1.5 | 81.6 |
| | | −6.19 | 1.23 | 1.9 | 31.3 |
| | | 103 | 2.19 | 1.5 | 81.6 |
| | | −9.67 | 0.1 | | |
| 9 | glass | 15.9 | 4.68 | 1.59 | 61.2 |
| | | −11.35 | 2 | | |

In the embodiment, the first lens 1 is an aspherical lens, the ninth lens 9 is an aspherical lens, and the other lenses are spherical lenses. Specifically, the spherical parameters corresponding to the aspherical lens are shown in Table 30:

| serial | | | | | |
|---|---|---|---|---|---|
| number | CONIC | A2 | A3 | A4 | A5 |
| 1 | 2.83 | 9.83e−6 | 3.06e−9 | −1.037e−11 | −5.68e−15 |
| | −0.847 | 1.07e−5 | 1.24e−7 | −5.16e−11 | −1.32e−12 |
| 9 | −2.1 | −8.78e−5 | 1.37e−7 | −1.79e−8 | 3.77e−12 |
| | −1.577 | −3.737e−5 | 6.699e−7 | −3.91e−8 | 4.77e−10 |

The optical projection system provided by the embodiment is capable of achieving the effect of the optical projection system provided by the embodiment Nine. In the embodiment, the system focal length of the optical projection system is from 2.5 mm to 3 mm; the angle of field of the optical projection system is from 53° to 59°; the diameter of the image circle is from 8.5 mm to 9.1 mm; the F-number of the system is from 1.65 to 1.75. The present system is suitable for a 0.23″ DMD TR 0.5 144% offset design. That is, the embodiments of the present disclosure constructs an optical architecture suitable for a 0.23″ DMD TR 0.5 144% offset by using nine lenses, which reduces the number of lenses used and reduces the volume of the optical projection system compared to the prior art.

### Embodiment Sixteen

Embodiment Sixteen differs from Embodiment Nine in that parameters of the curvature radius, thickness, and aspherical lens of each lens are different. In the embodiment, the specific parameters of each lens are shown in Table 31 below:

| lens | | curvature | | | abbe |
|---|---|---|---|---|---|
| serial | lens | radius | thickness | refractive | number |
| number | material | mm | mm | index Nd | Vd |
| 1 | plastic | 51.46 | 4.92 | 1.53 | 55.8 |
| | | 14.05 | 11.35 | | |
| 2 | glass | 38.36 | 2.86 | 1.7 | 41.1 |
| | | 9.98 | 5.46 | | |
| 3 | glass | −93 | 1.68 | 1.59 | 68.3 |
| | | 9.45 | 10.2 | | |
| 4/5 | glass | 22.13 | 2.35 | 1.91 | 35.3 |
| | | −59 | 1.09 | | |
| | | −43.25 | 10.923 | 17.8 | 25.7 |
| 6/7/8 | glass | 35.34 | 4.15 | 1.5 | 81.6 |
| | | −6.18 | 1.35 | 1.9 | 31.3 |
| | | 105 | 2.54 | 1.5 | 81.6 |
| | | −9.64 | 0.1 | | |
| 9 | glass | 15.9 | 4.64 | 1.59 | 61.2 |
| | | −11.55 | 2 | | |

The optical projection system provided by the embodiment is capable of achieving the effect of the optical projection system provided by the embodiment One. In the embodiment, the first lens 1 is an aspherical lens, the ninth lens 9 is an aspherical lens, and the other lenses are spherical lenses. Specifically, the spherical parameters corresponding to the aspherical lens are shown in Table 32:

| serial | | | | | |
|---|---|---|---|---|---|
| number | CONIC | A2 | A3 | A4 | A5 |
| 1 | 2.98 | 9.83e−6 | 3.07e−9 | −1.25e−11 | −5.34e−15 |
| | −0.874 | 1.08e−5 | 1.24e−7 | −5.14e−11 | −1.31e−12 |
| 9 | −2.11 | −8.21e−5 | 1.41e−7 | −1.805e−8 | 3.77e−10 |
| | −1.58 | −3.67e−5 | 6.49e−7 | −3.92e−8 | 4.772e−10 |

The optical projection system provided by the embodiment is capable of achieving the effect of the optical projection system provided by the embodiment Nine. In the embodiment, the system focal length of the optical projection system is from 2.5 mm to 3 mm; the angle of field of the optical projection system is from 53° to 59°; the diameter of the image circle is from 8.5 mm to 9.1 mm; the F-number of the system is from 1.65 to 1.75. The present system is suitable for a 0.23″ DMD TR 0.5 144% offset design. That is, the embodiments of the present disclosure constructs an optical architecture suitable for a 0.23″ DMD TR 0.5 144% offset by using nine lenses, which reduces the number of lenses used and reduces the volume of the optical projection system compared to the prior art.

The above embodiments focus on the differences between the embodiments, and the different optimization features between the embodiments may be combined to form a better embodiment as long as they are not contradictory, and in consideration of the conciseness, they will not be repeated herein.

1. An optical projection system, by comprising, a first lens group and a second lens group sequentially arranged along an optical axis from a zoom-in side to a zoom-out side, wherein the first lens group has a negative focal power, and the second lens group has a positive focal power:
wherein the first lens group comprises a negative lens group and a positive lens group, the positive lens group is located closer to the zoom-out side than the negative lens group, the negative lens group comprises at least one lens with a negative focal power, and the positive lens group comprises at least one lens with a positive focal power; and
the negative lens group and the positive lens group are provided with a first air gap greater than 9.5 mm therebetween.

2. The optical projection system of claim 1, wherein the first lens group and the second lens group are provided with a stop therebetween; the first lens group and the stop are provided with a second air gap therebetween, and the second air gap is greater than 8 mm and less than 11 mm; and/or the second lens group and the stop are provided with a third air gap therebetween, and the third air gap is 1.5% to 4.5% of a total optical length of the optical projection system.

3. The optical projection system of claim 1, wherein in the negative lens group, the lens with a negative focal power has a concave surface closer to the zoom-out side, and an edge tangent of the concave surface forms an angle ranging from 30° to 50° with the optical axis.

4. The optical projection system of claim 1, wherein from the zoom-in side to the zoom-out side, the negative lens group comprises a first lens, a second lens, and a third lens, each having a negative focal power.

5. The optical projection system of claim 1, wherein from the zoom-in side to the zoom-out side, the positive lens group comprises a fourth lens with a positive focal power; or, the positive lens group comprises a fourth lens and a fifth lens, each having a positive focal power.

6. The optical projection system of claim 4, wherein a sum of the focal power of the first lens, the second lens and the third lens ranges from −0.16 to −0.14.

7. The optical projection system of claim 1, wherein from the zoom-in side to the zoom-out side, clear apertures of the lenses in the optical projection system gradually decreases.

8. The optical projection system of claim 1, wherein from the zoom-in side to the zoom-out side, the negative lens group comprises a first lens, a second lens, and a third lens, the first lens has a greater thickness than the second lens, and the second lens has a greater thickness than the third lens.

9. The optical projection system of claim 4, wherein each of the first lens, the second lens, and the third lens has a first surface and a second surface, the second surface is closer to the zoom-out side, and the second surfaces of the first lens, the second lens, and the third lens are all concave surfaces:
an edge tangent of the second surface of the first lens forms an angle of 30° to 40° with the optical axis;
an edge tangent of the second surface of the second lens forms an angle of 30° to 40° with the optical axis; and
an edge tangent of the second surface of the third lens forms an angle of 40° to 50° with the optical axis.

10. The optical projection system of claim 4, wherein the first lens comprises an aspherical lens, and the first lens and the second lens are provided with a fourth air gap greater than 10 mm therebetween.

11. The optical projection system of claim 1, wherein from the zoom-in side to the zoom-out side, the second lens group comprises a sixth lens, a seventh lens, an eighth lens, and a ninth lens, focal powers of the second lens group being in an order of positive, negative, positive, and positive.

12. The optical projection system of claim 11, wherein the sixth lens, the seventh lens, and the eighth lens are cemented together to form a triple-cemented lens, and in the triple-cemented lens, a lens with a positive focal power has a smaller refractive index smaller than a lens with a negative focal power.

13. The optical projection system of claim 12, wherein the ninth lens comprises an aspherical lens, and an air gap between the triple-cemented lens and the ninth lens is less than 1 mm and greater than 0.1 mm.

14. An electronic device, comprising an optical projection system of claim 1.
